(19) United States
(12) Patent Application Publication
(10) Pub. No.: US 2025/0321735 A1
(43) Pub. Date: Oct. 16, 2025

(54) EFFICIENT DETECTION OF UPDATES IN A RESOURCE COLLECTION SET

(71) Applicant: Oracle International Corporation, Redwood Shores, CA (US)

(72) Inventors: Gregory Mueller Cole, Aptos, CA (US); Greg Gravenites, Littleton, CO (US); Arif Rafique, Parker, CO (US); Antony James Reynolds, Colorado Springs, CO (US)

(73) Assignee: Oracle International Corporation, Redwood Shores, CA (US)

(21) Appl. No.: 18/632,131

(22) Filed: Apr. 10, 2024

(51) Int. Cl. G06F 8/77

(52) U.S. Cl. CPC G06F 8/77

(57) ABSTRACT

Techniques are described herein for generating revision identifiers. An example method can include a first computing system detecting a revision of an asset stored in a project. The first computing system can generate an updated asset revision identifier, based at least in part on the revised asset. In some examples, the project can be associated with a project revision identifier that reflects one or more revisions of the project. The computing system can generate an updated project revision identifier based at least in part on the revised asset. The first computing system can transmit the project to a second computing system. The project can include the updated project revision identifier. The second computing system can be configured to detect the one or more revisions of the project, based at least in part on the updated project identifier.

### BACKGROUND

A cloud service provider (CSP) can engage in a software development cycle to develop a software solution to computing issues. The CSP can provide developers with a platform that includes tools, libraries, and other components to collaborate together and develop, create, and/or test the software solution. The platform can provide the components to develop different versions of the software, and then test and debug the different versions of the software. Once the different versions of the software have been tested and debugged, one of the versions of the software can be deployed to address the computing issue.

### BRIEF SUMMARY

Software development involves a process in which software can be developed in a development environment that is suited to iteration by a software development team. As the software matures, the software can be promoted from the development environment to a testing environment where the software can be executed in conjunction with other software. Upon further maturation, the software can be promoted from the testing environment to a preproduction environment for final testing prior to promotion to production (e.g., a more widely accessible “public” environment). At each stage in this software development lifecycle, it may be important for the software development team to have knowledge of what changes, if any, to the software occurred through the progression.

The embodiments described herein include a revision identifier that can be maintained for the software (e.g., per project or sub-project) throughout the development cycle. The revision identifier can assist in identifying which portions of a software being developed have been revised and a number of revisions. The software being developed can be organized as a project, which can be a file that can include various assets, such as integrations (e.g., executable scripts), connections (e.g., application programming interfaces (APIs)), lookups (e.g., tables or arrays), libraries (e.g., routines or subroutines), links (e.g., hyperlinks), and/or other appropriate assets. The project and each asset can include a revision identifier that can be a numeric value indicating a number of revisions to the project or asset. In some examples, a revision identifier for a project may be referred to as a project revision identifier, and a revision identifier for an asset may be referred to as an asset revision identifier.

Techniques and devices, including methods, computing systems, and one or more computer-readable media, are described herein for generating a revision identifier. An example computer-implemented method can include detecting one or more revisions of an asset stored in a project. The asset can be associated with a first revision identifier that reflects the one or more revisions to the asset, the project being associated with a project revision identifier that reflects one or more revisions of the project.

The computer-implemented method can further include generating an updated asset revision identifier of the asset, based at least in part on the one or more revisions of the asset.

The computer-implemented method can further include generating an updated project revision identifier based at least in part on the one or more revisions of the asset and the asset being stored in the project.

The method can further include the first computing system transmitting the project to a second computing system. The project can include the updated project revision identifier. The second computing system can be configured to detect the one or more revisions of the project, based at least in part on the updated project identifier.

An example first computing system can include one or more processors and one or more computer-readable media having stored thereon a sequence of instructions that, when executed, cause the one or more processors to detect one or more revisions of an asset stored in a project. The asset can be associated with an asset revision identifier that reflects the one or more revisions to the asset, the project being associated with a project revision identifier that reflects one or more revisions of the project.

The instructions, when executed, can further cause the one or more processors to generate an updated asset revision identifier of the asset, based at least in part on the one or more revisions of the asset.

The instructions, when executed, can further cause the one or more processors to generate an updated project revision identifier based at least in part on the one or more revisions of the asset and the asset being stored in the project.

The instructions, when executed, can further cause the one or more processors to transmit the project to a second computing system. The project can include the updated project revision identifier. The second computing system can be configured to detect the one or more revisions of the project based at least in part on the updated project identifier.

An example one or more computer-readable media can include stored thereon a sequence of instructions that, when executed by one or more processors of a first computing system, cause the first computing system to detect one or more revisions of an asset stored in a project. The asset can be associated with an asset revision identifier that reflects the one or more revisions to the asset, the project being associated with a project revision identifier that reflects one or more revisions of the project.

The instructions, when executed, can further cause the one or more processors to generate an updated asset revision identifier of the asset, based at least in part on the one or more revisions of the asset.

The instructions, when executed, can further cause the one or more processors to generate an updated project revision identifier based at least in part on the one or more revisions of the asset and the asset being stored in the project.

The instructions, when executed, can further cause the one or more processors to transmit the project to a second computing system. The project can include the updated project revision identifier. The second computing system can be configured to detect the one or more revisions of the project, based at least in part on the updated project identifier.

### BRIEF DESCRIPTION OF THE DRAWINGS

FIG. 1 is an illustration of an example system for managing software revisions, according to one or more embodiments.

FIG. 2 is an illustration of an example master project, according to one or more embodiments.

FIG. 3 is an illustration for an example process for incrementing revision identifier values, according to one or more embodiments.

FIG. 4 is an illustration of an example progression of steps for generating a revision identifier, according to one or more embodiments.

FIG. 5 is an example process flow for generating a revision identifier, according to one or more embodiments.

FIG. 6 is a block diagram illustrating one pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating an example computer system, according to at least one embodiment . . .

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A cloud service provider (CSP) can provide various software development services to its customers. For example, a customer may need to address a software need at the customer's computing system. Furthermore, based on various factors, such as cost, efficiency, knowledge base, the customer may make a request to the CSP to develop a software solution for the customer's computing system. In some instances, the software solution is an update of a previously developed solution. In other instances, the software solution is an update to a solution that was developed by the customer or some third party. In any event, a software development team can develop a software solution over the course of a software development cycle.

The software development cycle can include various stages, and at each stage, the software development team may only revise a portion of the project. For example, a project may include a first integration and a second integration, and at a stage of the software development cycle, the software development team may revise the first integration and not revise the second integration. A software developer at a subsequent stage of the software development cycle may desire the ability to access the project and determine whether any integration has been revised at a previous stage.

As described herein, the project and each asset of the project may be associated with a respective revision identifier. Each revision identifier may be a value indicating a number of revisions to the project or asset. As a project is created and an asset is added to the project, each newly added asset can have a revision identifier initialized at the same value. If an asset is deleted, a corresponding asset identifier can be deleted from the project. Continuing with the example from above, each of the first integration and the second integration can be initialized with a same revision identifier (e.g., 0) that can be used to track the number of revisions to the integration. Each time that either the first integration or the second integration is revised, the revision identifier can be changed/updated (e.g., incremented). For example, the revision identifier for the first integration can be incremented from a 0 to a 1. As the second integration may not have been revised, the revision identifier for the second integration can remain at 0. Therefore, the software developer at the subsequent stage of the software development cycle can look at the revision identifier for the first integration and the revision identifier for the second integration and determine that the first integration has been revised at least one more time than the second integration. In some instances, the asset can further include another identifier that indicates whether a revision is a major asset revision or a minor asset revision. A major asset revision can be a substantial revision of the underlying code of the asset. A minor asset revision can be a minor revision of the underlying code of the asset. The major/minor asset revision identifiers can be used by an entity that receives the project. For example, the entity receiving the project may configure their system differently based on whether an asset to be installed has a major revision or a minor revision. A major asset revision may require a greater number of steps for a proper installation than installing a minor asset revision.

This is different from a conventional system, in which a developer may need to compare the actual script of the first integration with a previously stored copy of the first integration to determine if a revision occurred. Depending on how voluminous each script is, this can be a time-consuming task. Furthermore, even if such a comparison task were to be performed by a computing system, this would require directing the processing capability of the system towards such a task, thereby inefficiently allocating the processing capabilities of the system. The described techniques herein provide a revision identifier that can assist a developer to identify a revision of an asset (e.g., an integration) or a set of assets without an exhaustive comparison of underlying code.

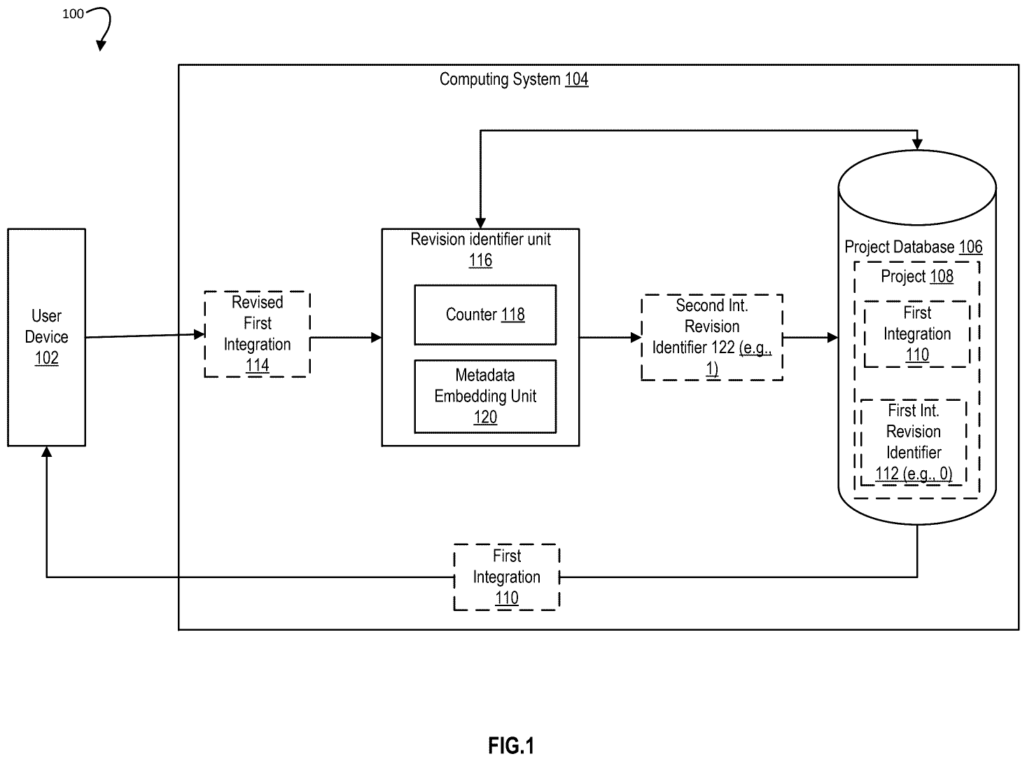

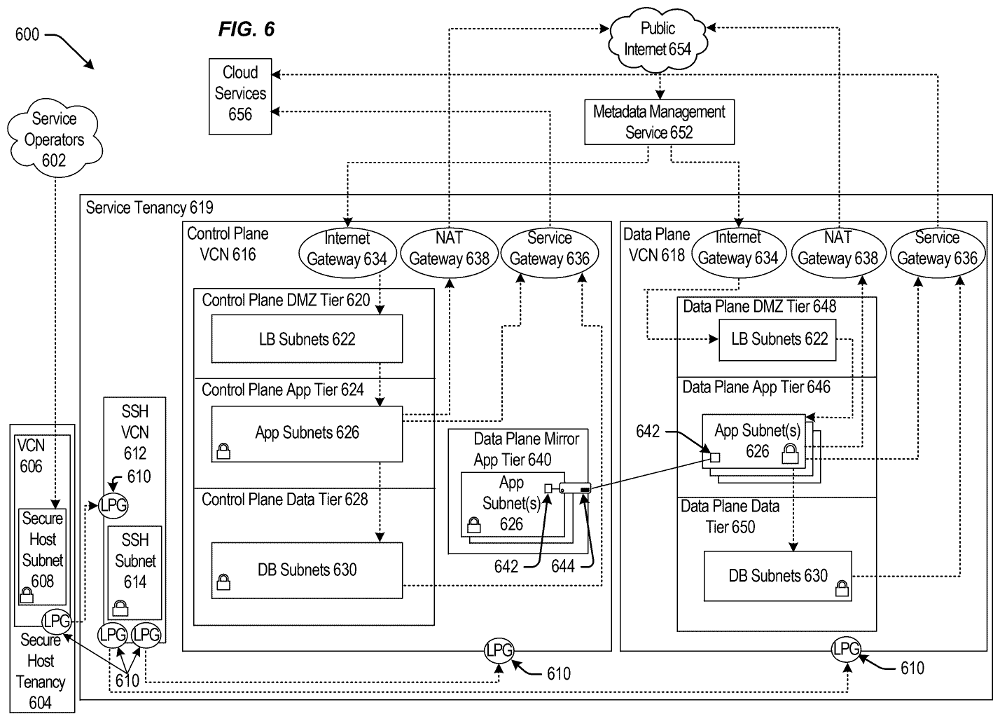

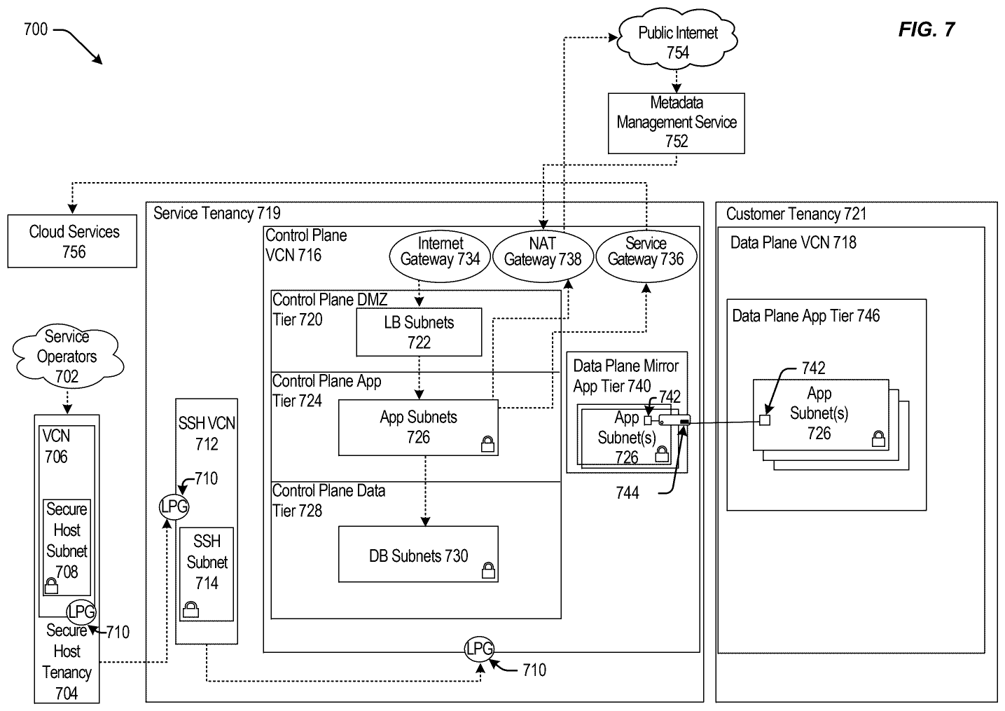

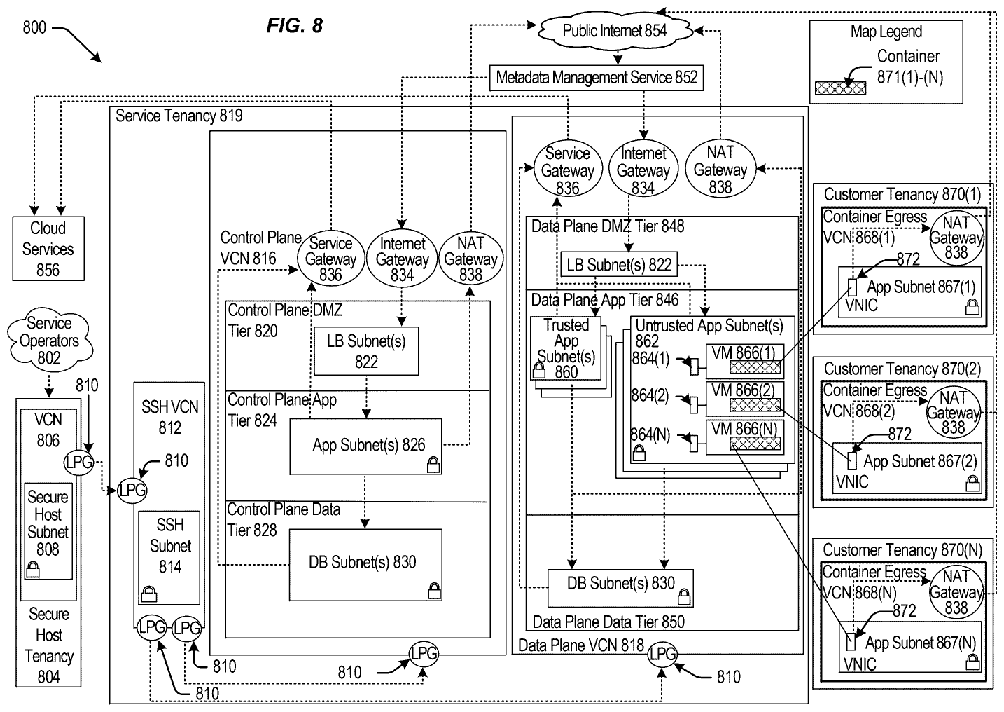

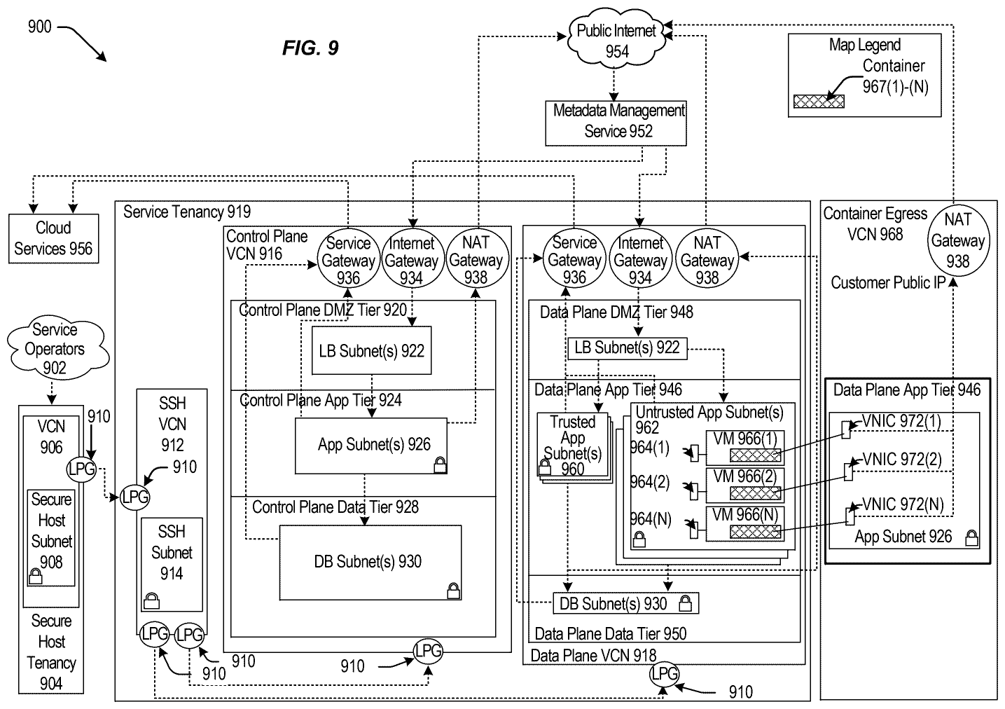

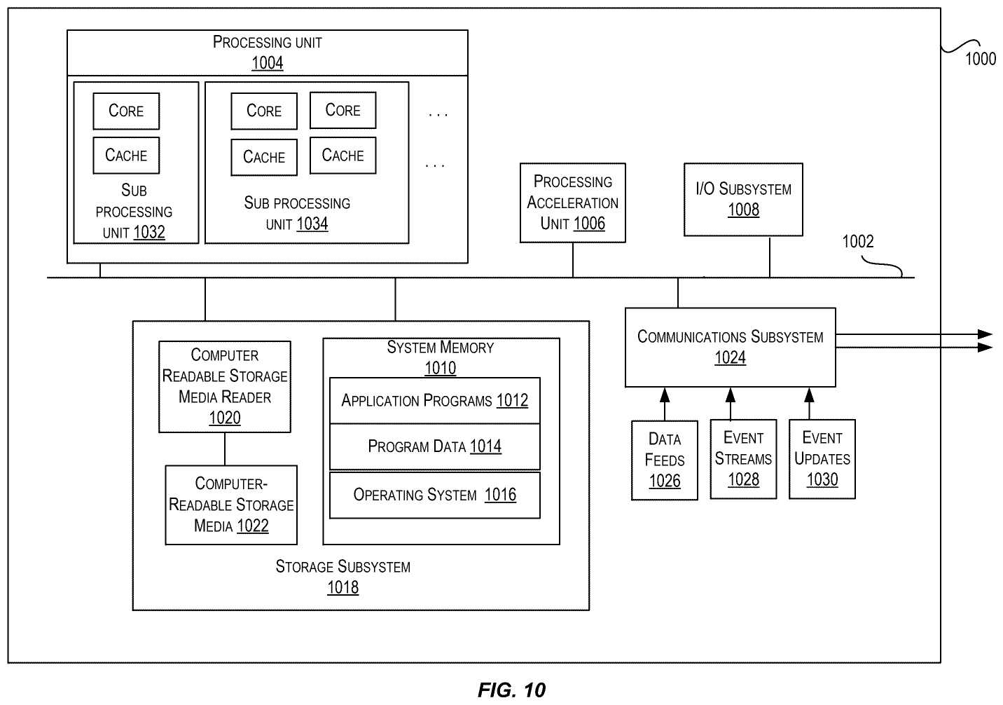

FIG. 1 is an illustration 100 of an example system for managing software revisions, according to one or more embodiments. A developer can use a user device 102 (e.g., laptop, personal computer) in operable communication with a computing system 104 to revise a project or a portion of a project during a stage of a software development cycle. As used herein, a revision can include an addition, a deletion, or an amendment of an asset or project. The computing system 104 can be managed by a CSP and implemented using architecture described in FIGS. 6-10. The user device 102 can access a project database 106 that is part of the computing system 104 and stores various projects to be updated. For example, the developer can be employed by a CSP, and a customer of the CSP can request one or more updates of the customer's software. For example, the customer may be a global entity that has a datastore that is unable to interface with the customer's chatbot software. The datastore's interface software may need to be updated to permit communication with the chatbot software. The CSP can access a copy of the datastore interface software from the customer and store it in the project database 106 as a project 108. The project 108 can then be moved through the software development cycle to revise the software and address the customer's needs.

The project 108 can include a set of assets (e.g., integrations, connections, lookups, libraries, and links). As illustrated, the project 108 includes a first integration 110 associated with a first integration revision identifier 112. Continuing with the example above, the first integration 110 can be executable script used with the datastore interface software. The first integration revision identifier 112 can be metadata that is associated with the first integration 110 and stored in the project 108. The first integration revision identifier 112 can be a value that is indicative of the number of revisions that the first integration 110 has undergone as part of the project 108. The first integration revision identifier can be initialized to a starting value (e.g., 0) at the time when the first integration 110 is added to the project 108. This may not necessarily be the first stage of a development life cycle, and can occur as a developer sees fit. It should be appreciated that project 108 can include additional assets (e.g., other integrations, connections, lookups, libraries, and links) and only the first integration 110 is illustrated for brevity.

The user device 102 can access the first integration 110 from the project database 106 and revise the first integration 110 to generate a revised first integration 114. For example, the user device 102 can be used to change one or more lines of script included in the first integration 110 to generate the revised first integration 114. At some point, the developer may wish to store the revised first integration 114 in the project database 106. The user device 102 can be used to select a file path that indicates a location in the project database 106 for storing the revised first integration 114. The file path can, for example, indicate the project 108 as the location for storing the revised first integration 114.

The revision identifier unit 116 can be in communication with user device 102 and the project database 106 and detect that the user device 102 is requesting to store the revised first integration 114. In some embodiments, a request to store an asset can be indicative of the asset having been revised. In other instances, a creation or deletion of an asset is indicative of an asset being revised. Based on the file path, the revision identifier unit 116 can determine the location of the project 108 and access the metadata stored (including the first integration revision identifier 112) in the project 108. The revision identifier unit 116 can further determine the value of the first integration revision identifier 112. For example, the value for the first integration revision identifier 112 can be “0.” The revision identifier unit 116 can transmit control instructions for instructing the counter 118 to determine an incremented value for a second integration revision identifier 122, where the second integration revision identifier 122 can be associated with the revised first integration 114. The counter 118 can access an increment value n from the computing system's memory, where the incremented value n can be the amount by which to increment the value of the first integration revision identifier 112. In this example, the increment value n can be “1.” The counter 118 can then determine the incremented value (e.g., current revision identifier value+increment value n=incremented value). In this example, the counter 118 can determine that the increment value for the second integration revision identifier 122 may be “1” (e.g., 0+1=1).

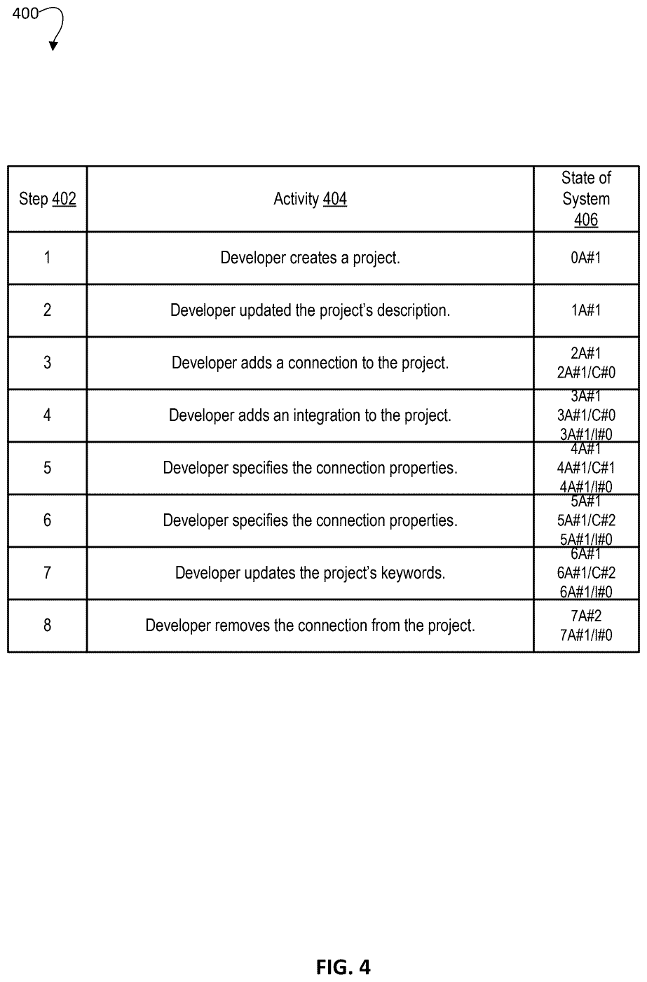

The counter 118 can communicate with the metadata embedding unit 120 to update metadata associated with the project 108 to indicate a second integration revision identifier 122 with the determined incremented value (e.g., in this example 1). The metadata embedding unit 120 can access the metadata stored in the project 108 and update the metadata to indicate the value of second integration revision identifier 122. An example process with values for incrementing a revision identifier value is described with more particularity with respect to FIG. 4.

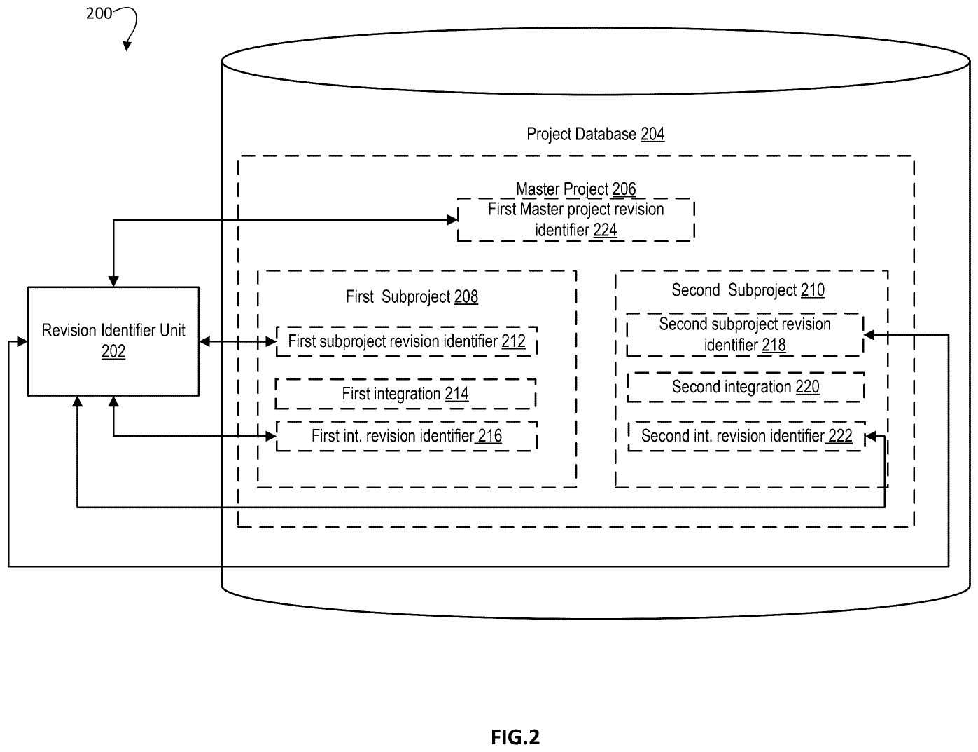

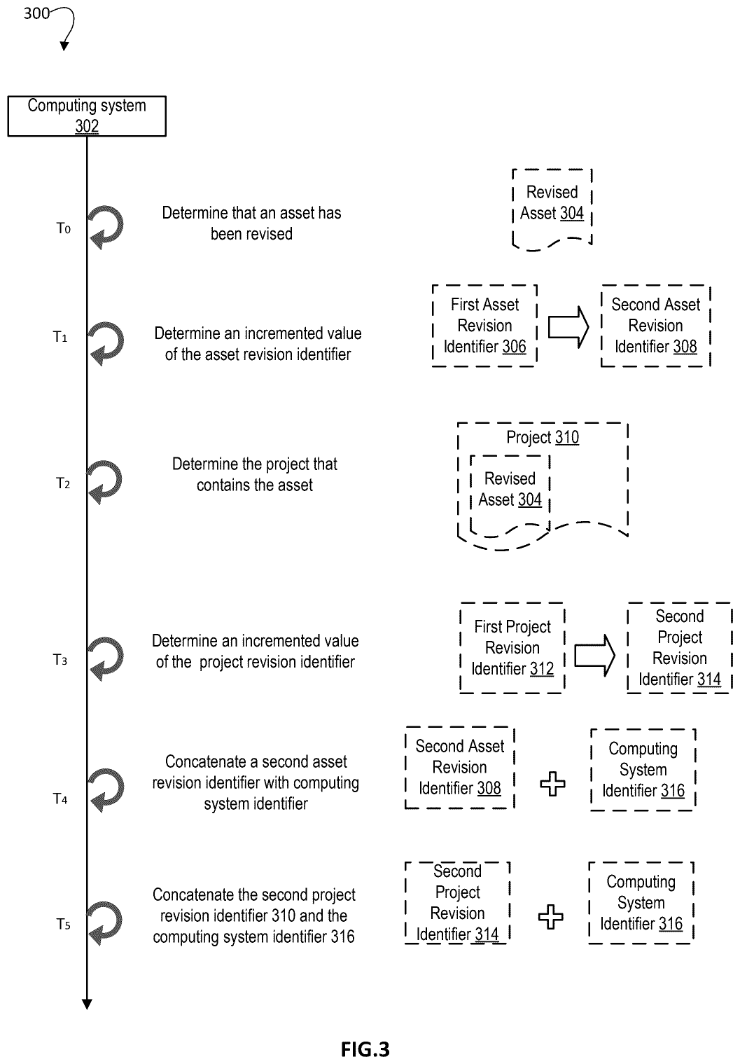

In some embodiments, the counter 118 can further determine an incremented value for the project 108 (e.g., a project revision identifier), which is a concept described with more particularity with respect to FIG. 2. In some additional embodiments, the metadata embedding unit 120 can concatenate the second integration revision identifier 122 with a computing system identifier. This concept is described with more particularity with respect to FIG. 3.

FIG. 2 is an illustration 200 of an example master project, according to one or more embodiments. The techniques described herein can be extended from revision identifiers for assets to revision identifiers for projects. To illustrate this concept, FIG. 2 includes a revision identifier unit 202 (e.g., revision identifier unit 116) in operable communication with a project database 204 (e.g., project database 106). In addition, to further illustrate this concept of project revision identifiers, an example with values has also been provided below the description of FIG. 2.

The project database 204 can be used to store a master project 206, where a master project 206 is a project that stores other projects. For example, the master project 206 can be a file and the subprojects can be subfiles stored in the file. The master project 206 and the subprojects can further share a common directory. As illustrated, the master project 206 can store a first subproject 208 (e.g., project 108) and a second subproject 210. The first subproject 208 can include a first subproject revision identifier 212 in the form of metadata. The first subproject revision identifier 212 can be a value that indicates a number of revisions to an asset (e.g., first integration 214) included in the first subproject 208. It should be appreciated that the value of the first subproject revision identifier 212 may not always match the value of the first integration revision identifier 216 (e.g., first integration revision identifier 112). Each time that the first integration 214 is revised, the value of an associated first integration revision identifier 216 is incremented. Furthermore, each time that the first integration 214 is revised, the value of a first subproject revision identifier 212 is incremented. However, as one asset in the first subproject 208 is revised, another asset in the subproject may not necessarily be revised. Therefore, the respective values of the revision identifiers in a subproject may not necessarily match each other or the first subproject revision identifier 212.

The second subproject 210 can include a second subproject revision identifier 218, a second integration 220, and a second integration revision identifier 222 in the form of metadata and associated with the second integration 220. Furthermore, the master project 206 can include a master project revision identifier 224 in the form of metadata. The master project revision identifier 224 can be a value that indicates a number of revisions that have occurred to one or more subprojects (e.g., the first subproject 208 and the second subproject 210).

As indicated with respect to FIG. 1, a user device (e.g., user device 102) may access the first integration 214, and make one or more revisions. The revision identifier unit 202 can detect that the user device has requested to store a revised first integration in the first subproject 208. As used herein, storing can include storing an instance of the revised first integration that is distinct from the first integration 214, or saving the revised first integration, such that the first integration 214 is saved over. Based on the detection, a counter (e.g., counter 118) can determine an incremented value for a second integration revision identifier based on the value of the first integration revision identifier 216 and an increment value n. In addition, the counter can further determine an incremented value for a second subproject revision identifier 218. A metadata embedding unit (e.g., metadata embedding unit 120) can add metadata to the master project 206 and the first subproject 208 to indicate the incremented values. The metadata embedding unit can also delete metadata (e.g., a revision identifier if the corresponding asset has been deleted).

The master project 206 can further include a second subproject 210. Each of the first subproject 208 and the second subproject 210 can be self-contained, such that an asset of one subproject cannot access an asset of the other project. A master project 206 may include more than one subproject based on the software to be developed during the software development cycle. For example, if a CSP is tasked with updating a complex computing system, more than one software system may be affected. Furthermore, it may be necessary to segregate the software systems into the first subproject 208 and the second subproject. For example, one of the subproject may use a language, protocol, or hardware that is incompatible with the other subproject. In another scenario, one subproject may include sensitive information that may only be accessed by authorized developers. In any event, there may be various reasons why a master project 206 is segregated in multiple subprojects. In the instance that a master project 206 is segregated into multiple subprojects, it may be beneficial for developers at a subsequent stage of the development cycle to have a convenient manner to determine whether the master project 206 was revised, and if so, which subproject was revised. Furthermore, if a subproject was revised, the developers at the subsequent stage of the development cycle may desire a convenient method for determining which asset has been revised.

The following example is provided with example values to illustrate the concept of updating the first master project revision identifier 224, the first subproject revision identifier 212 and the first integration revision identifier 216. Consider an example where the value for the first integration revision identifier 216 may be “0”, the value for the first subproject revision identifier 212 may be “1”, and the value for the master project revision identifier 224 may be 6. Furthermore, the increment value n may be “1.” The first integration 214 can be revised and the revision identifier unit 202 can detect a request to store the revised first integration (e.g., revised first integration 114) in the project database 204. Based on the detection, a counter can determine an incremented value for a third integration revision identifier based on the value of first integration revision identifier 216 and the increment value n as being “1” (e.g., 0+1=1). The counter can determine an incremented value for a third subproject revision identifier based on the value of the first subproject revision identifier and the increment value n as being “2” (e.g., 1+1=2). The counter can determine an incremented value for a second master project revision identifier based on the value of the first master project revision identifier and the increment value n as being 7 (e.g., 6+1=7). In this example, the second integration 220 may not have been revised. Therefore, the second subproject revision identifier 218 and the second integration revision identifier 222 can remain unchanged. The metadata embedding unit 120 can update the metadata to include the determined incremented values.

FIG. 3 is an illustration 300 for an example process for incrementing revision identifier values, according to one or more embodiments. As indicated above, the project (e.g., project, subproject) revision identifier value can be incremented based on an asset contained in the project being revised. Furthermore, a master project revision identifier value can be incremented based on a project contained in the master project being revised. For example, a project may be considered revised if an asset contained in the project is revised. FIG. 3 can provide a process for incrementing a project revision identifier based on incrementing an asset revision identifier.

At T₀, a computing system 302 (e.g., computing system 104) can determine that an asset has been revised. For example, a user can use a user device (e.g., user device 102) to access a project database (e.g., project database 106) and in particular, an asset to be revised. At a point in time, the computing system 302 can detect that the project database has received a request to store the revised asset 304. The request can include a file path indicating a project within which to store the revised asset 304.

At T₁, the computing system 302 can determine an incremented value for the asset revision identifier 306. For example, the computing system can include a counter (e.g., counter 118) that is configured to determine an incremented value based on the first asset revision identifier 306 and an incremented value n. The counter can use the file path to determine the project within which the revised integration is to be stored. The counter can further access metadata stored in the project to determine the current value of the first asset revision identifier 306. The counter can access information stored in the computing system to determine the increment value n. The counter can use the current value of the asset revision identifier and the increment value n to determine the incremented value for a second asset revision identifier 308.

At T₂, the computing system 302 can determine the identity and file location of project 310 that contains the revised integration (e.g., revised asset 304). For example, the computing system 302 can use the file path included in the request to store the revised integration (e.g., revised asset 304) to determine the identity and file location of the project 310.

At T₃, the computing system 302 can determine an incremented value of the project revision identifier 312. As indicated with respect to FIG. 2, the project 310 (e.g., first subproject 208) can also be associated with an identifier (e.g., project revision identifier 312). The project revision identifier 312 can be a value indicating the number of revisions that the project 310 has undergone. The counter can access metadata stored in the project to determine the current value of the project revision identifier 312. The counter can access information stored in the computing system 302 to determine the increment value n. The counter can use the value of the first project revision identifier 312 and the increment value n to determine the incremented value of the second project revision identifier 314. As indicated above, the value of the project revision identifier may not necessarily be the same as the second asset revision identifier 308.

At T₄, the computing system 302 can concatenate the second asset revision identifier 308 with a computing system identifier 316. The computing system identifier 316 can be a value that is used to identify the computing system 302. For example, the computing system identifier 316 can be a device identifier if the computing system 302 is a single device. The computing system identifier 316 can be a system identifier if the computing system 302 is a set of computing devices. The computing system identifier 316 can convey information as to the identity of the computing system upon which the revisions to either the integration or the project were made. At T₅, the computing system can concatenate the second project revision identifier 314 and the computing system identifier 316.

In the event that the project 310 is exported from the computing system 302 to another computing system (e.g., a developer at a subsequent stage of the software development cycle), this other computing system can use the computing system identifier 316 concatenated with the second asset revision identifier 312 to determine whether the project 310 is in a same state as when it was exported from the computing system 302. For example, a user can transmit an email or file contemporaneously with the project 310. The email or file can include the second asset revision identifier 308, the second project revision identifier 310, and computing system identifier 316. Additionally, the second asset revision identifier 308, the second project revision identifier 310, and computing system identifier 316 can be included in the metadata for the project. The other computing system (e.g., subsequent developer computing system) can compare the second revision identifiers, the second project revision identifiers, and the computing system identifiers. If one or more of the asset or project revision identifiers do not match, then it can be determined that either an integration or project revision occurred without the user's knowledge. If the computing system identifiers do not match, it can be determined that a revision occurred at a computing system other than the instance computing system 302. In either event, an end user at the other computing system can contact the user at the instance computing system 302 and discuss the discrepancy.

FIG. 4 is an illustration 400 of an example progression of steps for generating a revision identifier, according to one or more embodiments. The progression of steps is illustrated in a table format and can include a step column 502 for identifying a step number, an activity column 504 for describing an activity that occurs at the corresponding step, and a state of system column 506 for describing the corresponding revision identifiers at each step.

At step 1, a developer can create a project, which can be an empty file to be populated by assets used for a software solution. For example, at the beginning of a software development cycle, the developer can create a file to be used as a project for storing assets used for a software solution. The state of the system at step 1 can be presented in the following format: <project revisionID><projectID> #<projectsservicerevisionID>. Therefore, “0” can equate to an initial value for the project revision identifier (e.g., first subproject revision identifier 212), “A” can equate to the project identifier, and “0” can equate to an initial value for the project service revision identifier. For this example, all initial values can be set to 0. The created project can be created within a service instance. In some instances, any revision identifiers may only be relevant with respect to the particular service instance.

At step 2, the developer can update the project description. For example, the developer can add metadata to the project to provide a summary of the project. The summary can include, for example, “building a software solution for permitting a datastore to interface with an encryption algorithm.” Any change to the project can result in a change to the project revision identifier. Therefore, at step 2, the project revision identifier can be updated from a “0” to a “1.” The project identifier can remain “A.” The project's service revision identifier can be updated from a “0” to a “1” based on the summary update.

At step 3, the developer can add a connection to the project. It can be seen that the state of system for step 3 includes two entries. Any change to the project can result in a change to the project revision identifier. Therefore, for the project line (2A #1), the project revision identifier can be updated from a “1” to a “2”. The project identifier can remain an “A.” As the project description has not been edited, the project service revision identifier can remain a “1.” In this step, a new asset (e.g., connection″ C″) has been added to the project, and therefore a first asset line (2A #1/C#0) has been added to the state of system. The first asset line can be formatted as follows: <project revisionID><projectID> #<projectsservicerevisionid>/<assetID><assetrevisionID>. Therefore, the project revision identifier can be “2,” the project identifier can be “A,” and the project service revision identifier can be “1.” The asset identifier can be “C,” and the asset revision identifier can be initialized at “0.”

At step 4, the developer can add an integration to the project. As the developer has added a second asset, the state of system can include three line entries. For the project line (e.g., 3A #1), the project has been revised to include the integration; therefore, the project revision identifier can be updated from a “2” to a “3.” The project identifier can remain an “A.” the service revision identifier can remain a “1.” For the first asset line (3A #1/C#0), the project revision identifier can be updated from a “2” to a “3.” The project identifier can remain an “A” and the asset service revision identifier can remain a “1.” The asset identifier can remain a “C” and the asset revision identifier can remain a “0.” For the second asset line (3A #1/I #0), the project revision identifier can be a “3,” the project identifier can be an “A,” and the service revision identifier can be a “1.” The asset identifier can be an “I” and the asset service revision identifier can be initialized to “0.”

At step 5, the developer can specify a connection property. As no assets have been added or deleted, the number of line entries in the state of system can remain three. For the project line (4A #1), as the project has been revised via specification of the connection property, the project revision identifier can be updated from a “3” to a “4.” The project identifier can remain an “A,” and the project service revision identifier can remain a “1.” For the first asset line (4A #1/C#1), the project revision identifier can be updated from a “3” to a “4.” The project identifier can remain an “A,” and the project service revision identifier can remain a “1.” The asset identifier can remain a “C.” As the connection has been modified, the asset service revision identifier can be updated from a “0” to a “1.” For the second asset line (4A #1/I #0), the project identifier can be updated from a “3” to a “4.” As the integration was not revised, the rest of the values can remain the same.

At step 6, the developer can again specify connection properties. As no assets have been added or deleted, the number of line entries in the state of system can remain three. For the project line (5A #1), as the project has been revised via specification of the connection property, the project revision identifier can be updated from a “4” to a “5.” The project identifier can remain an “A,” and the project service revision identifier can remain a “1.” For the first asset line (5A #1/C#1), the project revision identifier can be updated from a “4” to a “5.” The project identifier can remain an “A,” and the project service revision identifier can remain a “1.” The asset identifier can remain a “C.” As the connection has been modified, the asset service revision identifier can be updated from a “1” to a “2.” For the second asset line (5A #1/I #0), the project identifier can be updated from a “4” to a “5.” As the integration was not revised, the rest of the values can remain the same.

At step 7, the developer can update the project's keywords. Each project can include keys included in the metadata, which can be used as search terms or to be quickly viewed by another developer to get a summary of the project. As no assets have been added or deleted, the number of line entries in the state of system can remain three. For the project line (6A #1), as the project has been revised via updating the project keywords, the project revision identifier can be updated from a “5” to a “6.” The project identifier can remain an “A,” and the project service revision identifier can be updated from a “1” to a “2” based on a revision of an existing portion (e.g., keywords) of the project. For the first asset line (6A #1/C#1), the project revision identifier can be updated from a “5” to a “6.” The project identifier can remain an “A,” and the project service revision identifier can remain a “1.” The asset identifier can remain a “C.” As the connection has been modified, the asset service revision identifier can remain a “2.” For the second asset line (6A #1/I #0), the project identifier can be updated from a “5” to a “6.” As the integration was not revised, the rest of the values can remain the same.

At step 8, the developer can remove the connection from the project. As the number of assets has been reduced from three to two, the number lines in the state of system can be reduced from three to two. For the project line (7A #1), as the project has been revised via removing the connection, the project revision identifier can be updated from a “6” to a “7.” The project identifier can remain an “A,” and the project service revision identifier can remain a “1.” As illustrated, the first asset line associated with the connection has been removed. For the second asset line (7A #1/I #0), the project identifier can be updated from a “6” to a “7.” As the integration was not revised, the rest of the values can remain the same.

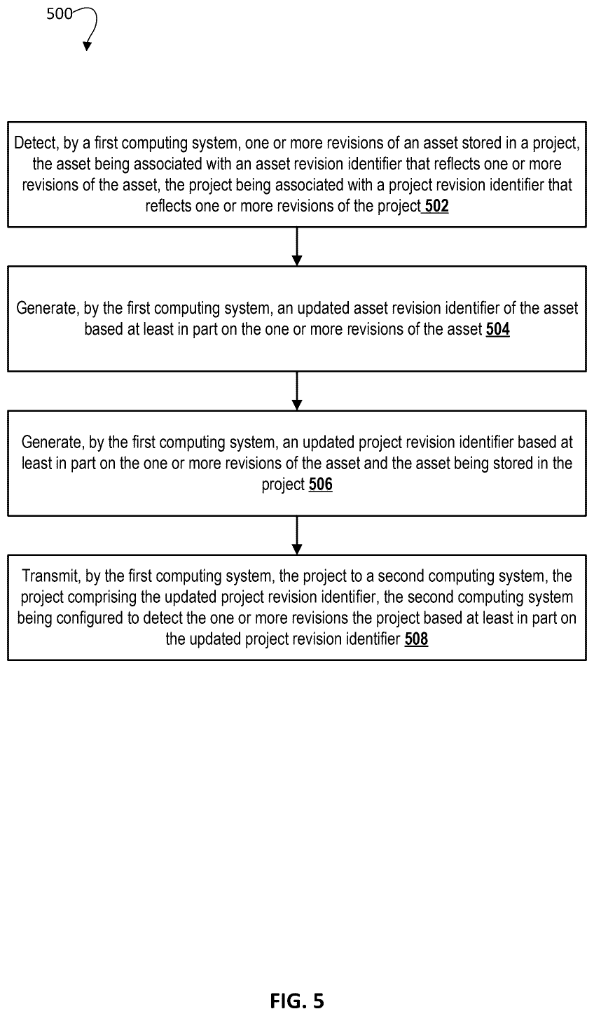

FIG. 5 is an example process flow 500 for generating a revision identifier, according to one or more embodiments. While the operations of process 500 are described as being performed by generic computers, it should be understood that any suitable device may be used to perform one or more operations of this process. Process 500 (described below) is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At 502, the method can include a first computing system detecting a revision of an asset (e.g., first integration 110) of a project (e.g., project 108). The asset revision identifier can reflect one or more revisions of the asset. The project can be associated with a project revision identifier (e.g., first subproject revision identifier 212). For example, the first computing system (e.g., computing system 104) can intercept a request from a user device (e.g., user device 102) to a project database (e.g., project database 106) to store a revised asset (e.g., revised first integration 114). In some instances, the act of requesting to store the asset can be indicative of one or more revisions of the asset. In other instances, a creation or deletion of an asset is indicative of one or more revisions of the asset.

At 504, the method can include the first computing system generating an updated asset revision identifier of the asset, based at least in part on the revision of the asset. The computing system can include a counter (e.g., counter 118) that can access the metadata to determine a current value of an asset revision identifier (e.g., first integration revision identifier 112). The counter can further access the computing system's memory to determine an increment value. The counter can use the current value of the asset revision identifier and the increment value to determine the incremented value for a second asset revision identifier (e.g., second integration revision identifier 122).

At 506, the method can include the first computing system generating an updated project revision identifier based at least in part on the revision of the asset and the asset being stored in the project. The counter can determine an incremented value for a second project revision identifier based on the value of the project revision identifier and the increment value.

At 508, the method can include the first computing system transmitting the project to a second computing system. The project can include the updated project revision identifier. The second computing system can be configured to detect a revision the project based at least in part on the updated project identifier. For example, a software development team can use the first computing system to assist in developing a software solution at a first stage of a software development cycle. Another development team may use a second computing system at a subsequent stage of the software development cycle. This software development team can use the revision identifiers to determine if the number of presented revisions aligns with the expected number of revisions. For example, the second computing system can be used to match the revision identifiers included in the project with the expected values of the revision identifiers. If the values match, the software development team can perform second stage operations for developing the software. If the values do not match, the software development team can determine the cause of the discrepancy.

### [Insert Boilerplate Here]

The invention claimed is:

1. A method, comprising:
detecting, by a first computing system, one or more revisions of an asset corresponding to a project, the asset being associated with an asset revision identifier that reflects the one or more revisions of the asset, the project being associated with a project revision identifier that reflects one or more revisions of the project;
responsive to detecting the one or more revisions of the asset:
generating, by the first computing system, an updated asset revision identifier of the asset based at least in part on the one or more revisions of the asset;
generating, by the first computing system, an updated project revision identifier based at least in part on the one or more revisions of the asset and the asset being stored in the project; and
transmitting, by the first computing system, the project to a second computing system, the project comprising the updated project revision identifier.

2. The method of claim 1, wherein generating the updated asset revision identifier comprises:
accessing metadata corresponding to the project to determine a value of the asset revision identifier;
accessing an increment value from a memory of the first computing system; generating an updated value for the updated asset revision identifier based at least in part on the value of the asset revision identifier and the increment value;
generating updated metadata comprising the updated asset revision identifier; and
storing the updated metadata.

3. The method of claim 1, wherein the method further comprises: concatenating the updated asset revision identifier with a first computing system identifier, wherein the project comprises the updated asset revision identifier concatenated with the first computing system identifier.

4. The method of claim 3, wherein the method further comprises:
concatenating the updated project revision identifier with the first computing system identifier, wherein the project comprises the updated project revision identifier concatenated with the first computing system identifier.

5. The method of claim 1, wherein generating the updated project revision identifier comprises:
accessing metadata corresponding to the project to determine a value of the project revision identifier;
accessing an increment value from a memory of the first computing system; generating an updated value for an updated project revision identifier based at least in part on the value of the project revision identifier and the increment value;
generating updated metadata comprising the updated value for the updated project revision identifier; and
storing the updated metadata.

6. The method of claim 1, wherein detecting the one or more revisions of the asset comprises detecting a creation of the asset.

7. The method of claim 1, wherein the asset is a first asset, and wherein the method further comprises:
detecting that a second asset has been added to the project;
generating metadata indicating that a second asset revision identifier associated with the second asset is set to an initial value; and
storing the metadata.

8. The method of claim 1, wherein the method further comprises:
detecting a message requesting to associate the asset with the project, wherein the message comprises a file path for storing the asset;
accessing the file path to determine an identity of the project; and
determining that the asset is associated with the project based at least in part on the file path.

9. The method of claim 1, wherein the asset is a first asset, and wherein the method further comprises:
detecting that a second asset has been deleted from the project; and
deleting a second asset revision identifier associated with the second asset, based at least in part on detecting that the second asset has been deleted.

10. The method of claim 1, wherein the method further comprises:
setting a value of the asset revision identifier to an initial value; and
setting a value of the project revision identifier to the initial value.

11. A first computing system comprising:
one or more processors; and
one or more computer-readable media having stored thereon a sequence of instructions that, when executed, cause the one or more processors to:
detect one or more revisions of an asset stored in a project, the asset being associated with an asset revision identifier that reflects the one or more revisions of the asset, the project being associated with a project revision identifier that reflects one or more revisions of the project;
responsive to the detection of the one or more revisions of the asset:
generate an updated asset revision identifier of the asset based at least in part on the one or more revisions of the asset;
generate an updated project revision identifier based at least in part on the one or more revisions of the asset; and
transmit the project to a second computing system, the project comprising the updated project revision identifier.

12. The first computing system of claim 11, wherein generating the updated asset revision identifier comprises:
accessing metadata corresponding to the project to determine a value of the asset revision identifier;
accessing an increment value from a memory of the first computing system;
generating an updated value for the updated asset revision identifier based at least in part on the value of the asset revision identifier and the increment value;
generating updated metadata comprising the updated asset revision identifier; and storing the updated metadata.

13. The first computing system of claim 11, wherein the instructions that, when executed, further cause the one or more processors to:
concatenate the updated asset revision identifier with a first computing system identifier, wherein the project comprises the updated asset revision identifier concatenated with the first computing system identifier.

14. The first computing system of claim 13, wherein the instructions that, when executed, further cause the one or more processors to:
concatenate the updated project revision identifier and the first computing system identifier, wherein the project comprises the updated project revision identifier concatenated with the first computing system identifier.

15. The first computing system of claim 11, wherein generating the updated project revision identifier comprises:
accessing metadata corresponding to the project to determine a value of the project revision identifier;
accessing an increment value from a memory of the first computing system; generating an updated value for an updated project revision identifier based at least in part on the value of the project revision identifier and the increment value;
generating updated metadata comprising the updated value for the updated project revision identifier; and
storing the updated metadata.

16. The first computing system of claim 11, wherein detecting the one or more revisions of the asset comprises detecting a creation of the asset.

17. The first computing system of claim 11, wherein the instructions that, when executed, further cause the one or more processors to:
set a value of the asset revision identifier to an initial value; and
set a value of the project revision identifier to the initial value.

18. One or more non-transitory computer-readable media comprising instructions which, when executed by one or more hardware processors of a first computing system, cause the first computing system to:
detect one or more revisions of an asset stored in a project, the asset being associated with an asset revision identifier that reflects the one or more revisions of the asset, the project being associated with a project revision identifier that reflects one or more revisions of the project;
responsive to the detection of the one or more revisions of the asset:
generate an updated asset revision identifier of the asset based at least in part on the one or more revisions of the asset;
generate an updated project revision identifier based at least in part on the one or more revisions of the asset; and
transmit the project to a second computing system, the project comprising the updated project revision identifier.

19. The one or more non-transitory computer-readable media of claim 18, wherein generating the updated asset revision identifier comprises:
accessing metadata corresponding to the project to determine a value of the asset revision identifier;
accessing an increment value from a memory of the first computing system; generating an updated value for the updated asset revision identifier based at least in part on the value of the asset revision identifier and the increment value;
generating updated metadata comprising the updated value for the updated asset revision identifier; and
storing the updated metadata.

20. The one or more non-transitory computer-readable media of claim 18, wherein the instructions further cause the first computing system to:
concatenate the updated asset revision identifier with a first computing system identifier, wherein the project comprises the updated asset revision identifier concatenated with the first computing system identifier.
